(19) United States
(12) Patent Application Publication
(10) Pub. No.: US 2004/0251568 A1
(43) Pub. Date: Dec. 16, 2004

(54) Polarizer manufacturing method

(75) Inventors: Chi-Yu Chao, Taipei (TW); Wen-Jiunn Hsieh, Taipei (TW)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Chunghwa Pictures Tubes, Ltd., Taipei (TW)

(21) Appl. No.: 10/681,600

(22) Filed: Oct. 8, 2003

(30) Foreign Application Priority Data
Jun. 10, 2003 (TW) 92115756

(51) Int. Cl. B29D 11/00

(52) U.S. Cl. 264/1.34; 264/2.5

(57) ABSTRACT

The present invention provides a polarizer manufacturing method. Dichroic molecule material is printed over the polarizer substrate by microcontact printing. A shear force generated from the microcontact printing process can arrange the Dichroic molecule in a particular direction.

### FIELD OF THE INVENTION

The present invention relates to a manufacturing method, and more particularly to a polarizer manufacturing method.

### BACKGROUND OF THE INVENTION

A polarizer is a basis component of a liquid crystal display (LCD). It is a transparent plate that only permits light having a particular direction to pass therethrough. When manufacturing the LCD panel, two interlaced polarizers are used to clip the LCD panel. The main function of the two interlaced disposed polarizers is to block or to transmit the illumination light.

FIG. 1A illustrates a TN-type LCD. When a zero voltage is applied to the LCD, the liquid crystal molecule 104 can be arranged according to the arrangement orientation of the up and down glass substrates 102 and 106. When a light 110 illuminates the LCD panel and passes through the polarizer 100, the light is twisted in the arranged direction of the liquid crystal molecule 104 to pass through the polarizer 108. The pixel appears white. When a voltage is applied to the LCD, the liquid crystal molecule 104 can be arranged as shown in the FIG. 1B. When a light 110 illuminates the LCD panel and passes through the polarizer 100, the light is not twisted. Therefore, the light 110 is blocked by the polarizer 108. The pixel appears dark.

FIG. 2 illustrates a schematic diagram of a polarizer. Dichroic molecule material is used to form the conventional polarization film of a polarizer. A dichroic material (such as the iodine series or the dyes series) is diffused into the transparent macromolecule film (such as a PVA). Then, the transparent macromolecule film is heated and is stretched by a uniaxial stretching method to adsorb the diffused dichroic material to form the polarization base 200. The originally disordered PVA molecule and the absorbed dichroic material molecule can be regularized by the stretching method. Therefore, the polarization base 200 can absorb the light arranged in parallel to it and to pass through the light arranged perpendicular to it. After finishing the polarization base 200, two TAC films 202 are respectively adhered to the up and down surfaces of the polarization base 200. Then, a protection film 204 is formed over a TAC film for protecting this film. Finally, an adhering layer 206 is formed over the other TAC film for adhering this film to the liquid crystal substrate. Before adhering this film, a separating film is used to protect the adhering layer 206.

The arrangement technology of the dichroic material is the key technology for manufacturing the polarization base 200. However, it is not perfect for using the uniaxial stretching method to regularize the dichroic material. Therefore, the optical characteristics thereof, such as the transmittance, the polarized ratio and extinction ratio, are bad for using the uniaxial stretching method to manufacture the polarizer. Moreover, the mechanical strength of the polarization base 200 is reduced due to the stretching process. Therefore, an additional protection layer is required to intensify the mechanical strength.

### SUMMARY OF THE INVENTION

According to the above descriptions, the main object of the present invention is to provide a polarizer manufacturing method. A shear force is used to regularize the dichroic material to increase the optical characteristic.

Another object of the present invention is to provide a polarizer manufacturing method that does not use an uniaxial stretching apparatus to regularize the dichroic material. Therefore, this method provides an easily manufacturing advantages and the manufacturing cost can be reduced.

The present invention provides a polarizer manufacturing method. Reactive Ionic etching(RIE) is first used to illuminate a glass substrate to form a master mold used in the microcontact printing process of the present invention. Next, a molding process is used to copy the pattern formed in the master mold to form a stamp. After finishing the stamp, a dichroic material or a birefringent material is coated on the stamp. Then, the coated stamp contacts the surface of the polarization base to perform the microcontact printing process to transfer the dichroic material to the surface of the polarization base. Then, a heating process is performed to drying the dichroic material solution to form the dichroic thin film. Finally, a protection layer is coated on the surface of the dichroic thin film for protecting the polarization base.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A illustrates a schematic diagram of a TN-type LCD when a zero voltage is applied to the LCD;

FIG. 1B illustrates a schematic diagram of a TN-type LCD when a non-zero voltage is applied to the LCD;

FIG. 2 illustrates a schematic diagram of a polarizer;

FIG. 3A to FIG. 3C illustrates a flow chart of forming a stamp according to the present invention;

FIG. 4 illustrates a schematic diagram of forming a dichroic material on the stamp;

FIG. 5 illustrates a schematic diagram of printing the dichroic material on the polarization base;

FIG. 6 illustrates a schematic diagram of the polarization base when the dichroic material is formed thereon; and

FIG. 7 illustrates a schematic diagram of the polarizer in according to the present invention.

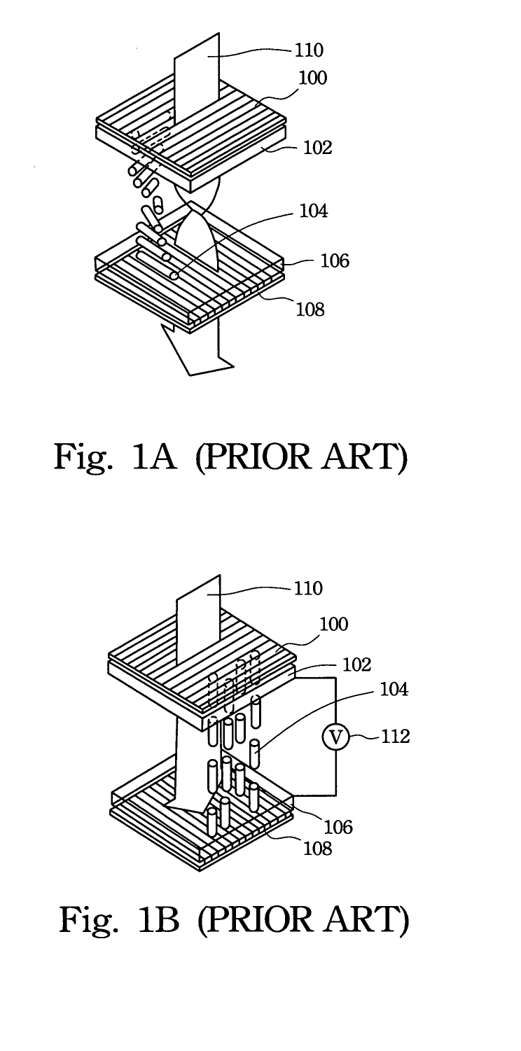

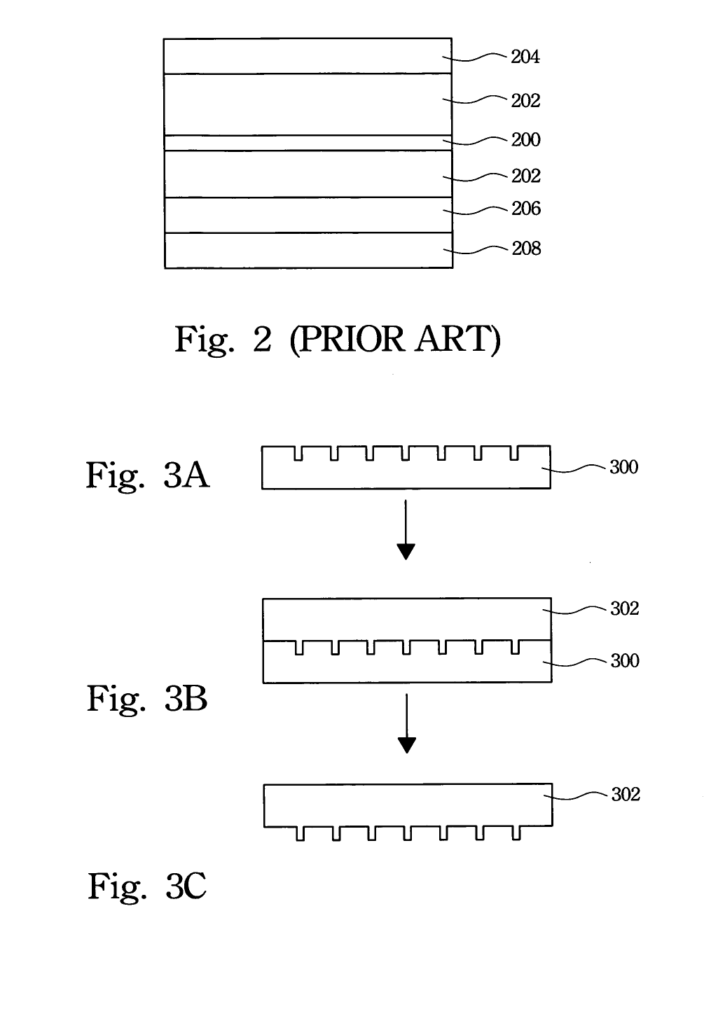

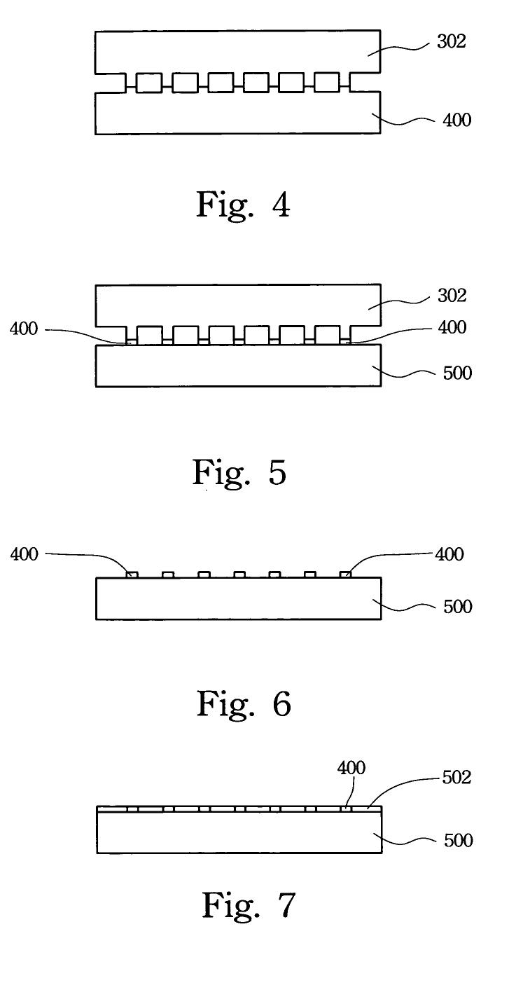

### DETAILED DESCRIPTION OF THE PREFERRED EMBODIMENT

Without limiting the spirit and scope of the present invention, the polarizer manufacturing method proposed in the present invention is illustrated with one preferred embodiment. One of ordinary skill in the art, upon acknowledging the embodiment, can apply the polarizer manufacturing method of the present invention to various liquid crystal display. Accordingly, a shear force is used to regularize the dichroic material. Therefore, the optical characteristic can be improved. Moreover, the method does not use the uniaxial stretching apparatus to regularize the dichroic material. Therefore, this manufacturing cost can be reduced. The application of the present invention is not limited by the preferred embodiments described in the following.

The polarizer manufacturing method of the present invention adopts the microcontact printing method. The dichroic material, such as the iodine series or the dyes series, is printed over the polarizer substrate by the microcontact printing method. A shear force is generated during the printing process to regularize the dichroic molecule in a particular direction.

A stamp needs to be formed first when using the microcontact printing method to form the polarizer. Referring to FIG. 3A to FIG. 3C, a flow chart of forming a stamp according to the present invention is illustrated. Referring to FIG. 3A first, a Reactive Ionic etching used to illuminate the glass substrate to form the pattern of the polarizer. This glass substrate is used as a master mold 300. The illuminated interval is less than about 100 nm and the illuminated depth is about 0.1 μm to 100 μm.

Referring to FIG. 3B, after finishing the master mold 300, a molding process is performed to copy the pattern formed on the master mold 300 to form the stamp 302. According to the modeling process, a macromolecule material, such as a PDMS, is first coated on the master module 300. Then, a hardening process is performed to harden the macromolecule material to form the stamp 302. Finally, the stamp 302 is separated from the master module 300. The stamp 302 is illustrated in the FIG. 3C. The stamp 302 is used to manufacture the polarizer.

When performing the microcontact printing process, a dichroic material or a birefringent material is coated on the stamp 302. According to the polarizer manufacturing method of the present invention, the stamp 302 is reversed and inserted into the ink pad 400 composed of a dichroic material or a birefringent material. That is, the pattern face of the stamp 302 is dipped into the ink pad 400. Therefore, the stamp 302 is stained with the ink pad 400. Using the dichroic material as the ink pad 400 is described in the following preferred embodiment.

Referring to FIG. 5, after the stamp is stained with the dichroic material 400, the pattern face of the stamp 302 contacts the surface of the polarization base 500 to perform the printing process to transfer the dichroic material 400 to the surface of the polarization base 500. The material of the polarization base 500 is glass. Then, a drying process is performed to drying the dichroic ink pad 400 to form the dichroic thin film. The stamp 302 can be separated from the dichroic material 400 after or before forming the dichroic thin film.

FIG. 6 illustrates a schematic diagram of the polarization base 500 when the dichroic material 400 is formed thereon. According to the present invention, a shear force is generated when the stamp 302 prints the dichroic material 400 on the polarization base 500. This molecule of the dichroic material 400 is regularized by the shear force, which can improve the regularity of the molecule arrangement. Therefore, the optical characteristic can be improved. Moreover, the method does not use the uniaxial stretching apparatus to regularize the dichroic material 400. Therefore, this manufacturing cost can be reduced.

Referring to FIG. 7, a protection layer 502 is coated over the surface of the polarization base 500 to protect the dichroic material 400 and the polarization base 500. Finally, a curing process is performed to harden the protection layer 502. Then, the polarizer is finished.

Accordingly, a shear force is generated when the stamp prints the dichroic material on the polarization base. This shear force is used to regularize the dichroic material molecule, which is better than the conventional uniaxial stretching method to arrange the dichroic material molecule. Therefore, the structure strength can be maintained. Moreover, the uniaxial stretching apparatus is not necessary in the present invention, which also reduces manufacturing costs.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. A polarizer manufacturing method using a stamp to form said polarizer, said method comprising:
forming a polarizing light material layer over a pattern surface of said stamp;
making said pattern surface of said stamp contact a polarization base to print said polarizing light material on said polarization base; and
drying said polarizing light material over said polarization base.

2. The polarizer manufacturing method according to claim 1, wherein a drying process is used to harden said polarizing light material.

3. The polarizer manufacturing method according to claim 1, wherein said polarizing light material is a dichroic material.

4. The polarizer manufacturing method according to claim 1, wherein said polarizing light material is a birefringent material.

5. The polarizer manufacturing method according to claim 1, wherein said stamp is separated from said polarization base after drying said polarizing light material.

6. The polarizer manufacturing method according to claim 1, wherein said stamp is separated from said polarization base before drying said polarizing light material.

7. A polarizer manufacturing method, said method comprising:
forming a master mold;
copying a pattern of said master mold to a stamp;
forming a polarizing light material layer over a pattern surface of said stamp;
making said pattern surface of said stamp contact a polarization base to print said polarizing light material to said polarization base; and
performing a evaporizing process to dry said polarizing light material over said polarization base.

8. The polarizer manufacturing method according to claim 7, wherein said master mold is formed by using an Reactive Ionic etching to depict a required pattern in a glass substrate.

9. The polarizer manufacturing method according to claim 7, wherein a evaporizing process is used to drying said polarizing light material.

10. The polarizer manufacturing method according to claim 7, wherein said polarizing light material is a dichroic material.

11. The polarizer manufacturing method according to claim 7, wherein said polarizing light material is a birefringent material.

12. The polarizer manufacturing method according to claim 7, wherein said stamp is separated from said polarization base after drying said polarizing light material.

13. The polarizer manufacturing method according to claim 7, wherein said stamp is separated from said polarization base before drying said polarizing light material.

14. A polarizer manufacturing method, said method comprising:
forming a master mold;
copying a pattern of said master mold to a stamp;
forming a polarizing light material layer over a pattern surface of said stamp;
making said pattern surface of said stamp contact a polarization base to print said polarizing light material on said polarization base;
drying said polarizing light material over said polarization base;
forming a protection layer over said polarization base; and
performing a drying process.

15. The polarizer manufacturing method according to claim 14, wherein said master mold is formed by using an Reactive Ionic etching to depict a required pattern in a glass substrate.

16. The polarizer manufacturing method according to claim 14, wherein a evaporizing process is used to dry said polarizing light material.

17. The polarizer manufacturing method according to claim 14, wherein said polarizing light material is a dichroic material.

18. The polarizer manufacturing method according to claim 14, wherein said polarizing light material is a birefringent material.

19. The polarizer manufacturing method according to claim 14, wherein said stamp is separated from said polarization base after drying said polarizing light material.

20. The polarizer manufacturing method according to claim 14, wherein said stamp is separated from said polarization base before drying said polarizing light material.
